(19) United States
(12) Patent Application Publication
(10) Pub. No.: US 2023/0320244 A1
(43) Pub. Date: Oct. 12, 2023

(54) HAYMAKING MACHINE WITH IMPROVED HYDRAULIC LIGHTENING AND METHOD FOR ITS OPERATION

(71) Applicant: KUHN SAS, SAVERNE (FR)

(72) Inventors: Christian GANTZER, WOUSTWILLER (FR); Thomas CORNIL, STEINBOURG (FR)

(73) Assignee: KUHN SAS, SAVERNE (FR)

(21) Appl. No.: 18/296,622

(22) Filed: Apr. 6, 2023

(30) Foreign Application Priority Data
Apr. 7, 2022 (FR) 22 03192

(51) Int. Cl. A01B 63/10; A01B 63/108

(52) U.S. Cl. CPC A01B 63/1006; A01B 63/108

(57) ABSTRACT

The invention relates to an agricultural machine intended to be coupled to a tractor vehicle and comprising a work unit connected to a chassis relative to which the work unit can be moved, the machine being able to take up a work configuration in which the work unit rests at least partially on the ground and a transport configuration in which the work unit is raised from the ground. The machine comprises a lightening device having at least one lightening cylinder connected to the chassis on one side and to the work unit on the other side, the lightening cylinder being able to transfer, in the work configuration, at least some of the weight of the work unit onto the chassis.

### BACKGROUND OF THE INVENTION

### Field of the Invention

The present invention relates to the field of agricultural machinery and in particular agricultural haymaking machines.

The invention relates more specifically to an agricultural machine intended to be coupled to a tractor vehicle and comprising a work unit connected to a chassis relative to which the work unit can be moved, the machine being able to take up a work configuration in which the work unit rests at least partially on the ground and a transport configuration in which the work unit is raised from the ground. The machine comprises a lightening device with at least one lightening cylinder connected to the chassis on one side and to the work unit on the other side, the lightening cylinder being able to transfer, in the work configuration, at least some of the weight of the work unit onto the chassis.

### Description of the Related Art

In a known manner, on agricultural machines with a heavy work unit, this work unit is lightened by one or more cylinder(s) connected to one or even several hydropneumatic pressure accumulators, to avoid damaging the plant cover over which it slides or rolls during its operation. A drawback with this type of lightening systems is that the weight of the work unit transferred onto the chassis is not constant (the same is true for lightening by springs): the work unit is often lightened more when it is at the bottom than when it is at the top of its vertical stroke. If the lightening is too great, when the work unit is raised, for example after crossing a protrusion in the ground, a certain amount of time is required before the work unit reaches the ground again, resulting in poor working quality at this point. Too weak lightening, for its part, may bring about damages to the plant cover and/or the work unit. In addition, since the hydropneumatic pressure accumulators are pressurized energy reserves, they are particularly dangerous and require special precautions during their assembly, when using the machine, and even when shipping the machine if they exceed a certain volume. Consequently, each pressure accumulator must be checked regularly, and additional safety components are required, such as a safety valve, for example.

Document DE 3628427 describes a machine of the type mentioned in the introduction. On this machine, a first chamber of the lightening cylinder can be connected to the pump by a pressurized pipe and a second chamber to a tank by a return pipe, these pipes being connected together by a pressure limiting valve. Such a hydraulic arrangement makes it possible to reduce the support pressure of the work unit on the ground so as to avoid damaging the plant cover over which it moves, while allowing some adjustment of this pressure. On this device, the pressure is measured in the pressurized pipe and, if this measured pressure is greater than a set value, a signal is sent to the pressure limiting valve so that it allows more fluid to flow from the pump to the tank (without passing through the cylinder). The oil of the pressurized pipe can therefore be diverted to the return pipe, thereby making it possible to reduce the pressure in the first chamber of the cylinder. When the pressure measured in the pressurized pipe (equal to that of the first chamber) is less than the adjustment setpoint, the pressure limiting valve is closed (again), so that the pressure in the chamber increases again.

With such a hydraulic arrangement, even when the pressure limiting valve allows fluid to flow to the tank without passing through the cylinder, the pump must always supply a pressure greater than the set value of the pressure limiting valve in order to keep it in the ‘open’ configuration. It appears from the above that, regardless of the pressure measured in the first chamber, the pump must constantly supply the circuit with pressurized oil, whether the oil is directed to the lightening cylinder and/or to the tank. Having to continuously supply pressurized oil requires a large quantity of energy, respectively of fuel, and is therefore not cost effective. In addition, oil which is continuously pressurized is likely to heat up, which may alter its properties and reduce the efficiency of the machine. In addition, in document DE 3628427, control of the pressure limiting valve, respectively transmission of the adjustment signal, is carried out electromagnetically, which requires an additional system and extra components, thereby making the machine more complex and increasing its cost price.

### SUMMARY OF THE INVENTION

The main objective of the present invention is to overcome at least partially the above-mentioned problems, and in particular avoid the use of a pressure accumulator.

Thus, the invention relates to an agricultural machine intended to be coupled to a tractor vehicle and comprising a work unit connected to a chassis relative to which the work unit can be moved, the machine being able to take up a work configuration in which the work unit rests at least partially on the ground and a transport configuration in which the work unit is raised from the ground. The machine comprises a lightening device having at least one lightening cylinder connected to the chassis on one side and to the work unit on the other side, the lightening cylinder being able to transfer, in the work configuration, at least some of the weight of the work unit onto the chassis. The machine is characterized in that the lightening device comprises a pressure control valve connected to an active chamber of the lightening cylinder by a first pipe, the pressure control valve taking up, when the pressure in the first pipe is less than a set value, a first position in which it allows hydraulic fluid to flow between the first pipe and a second pipe connecting the pressure control valve to a hydraulic pump in the work configuration of the machine, the pressure control valve taking up, when the pressure in the first pipe is greater than the set value, a second position in which it allows hydraulic fluid to flow between the first pipe and a third pipe connecting the pressure control valve to a tank in the work configuration of the machine.

### BRIEF DESCRIPTION OF THE DRAWINGS

The invention will be better understood from the following description, which refers to a preferred embodiment given as a non-limiting example and explained with reference to the attached schematic drawings, in which:

FIG. 1 is a side elevation view of an agricultural machine according to the invention, coupled to the front of a tractor vehicle and in the work configuration.

FIG. 2 is a perspective view of the object shown on FIG. 1.

FIG. 3 is a side elevation view of an agricultural machine according to the invention, coupled to the front of a tractor vehicle and in the transport configuration.

FIG. 4 represents a side elevation view of an agricultural machine according to a variant of the invention in which the chassis is an integral part of the machine.

FIG. 5A symbolically represents a hydraulic circuit of the lightening device of the machine according to the invention.

FIG. 5B symbolically represents another possible hydraulic circuit of the machine according to the invention.

FIG. 5C symbolically represents yet another possible hydraulic circuit of the machine according to the invention.

### DETAILED DESCRIPTION OF THE PREFERRED EMBODIMENTS

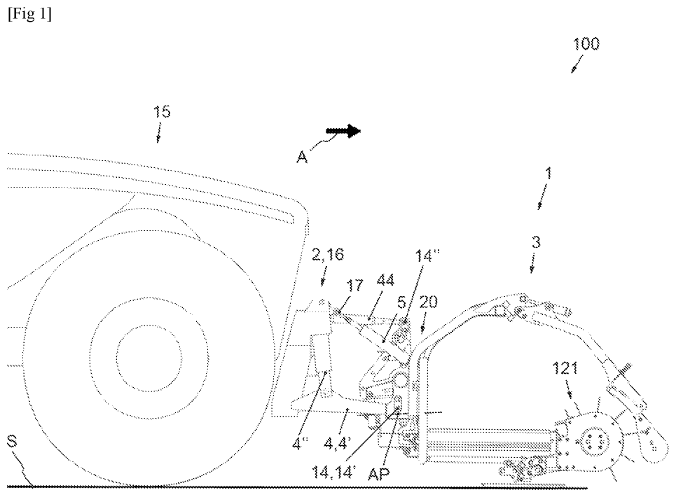

FIGS. 1 et 2 show an agricultural machine 1 intended to be coupled to a tractor vehicle 15. The machine 1 comprises a work unit 3 connected to a chassis 2 relative to which the work unit 3 can be moved. The machine 1 can take up a work configuration in which the work unit 3 rests at least partially on the ground S. The machine 1 can also take up a transport configuration in which the work unit 3 is raised from the ground S. The machine 1 comprises a lightening device 9 having at least a lightening cylinder 5 connected to the chassis 2 on one side. The lightening cylinder 5 is connected to the work unit 3 on the other side. The lightening cylinder 5 can transfer, in the work configuration, at least some of the weight of the work unit 3 onto the chassis 2.

According to the invention, the lightening device 9 comprises a pressure control valve 6 connected to an active chamber 5′ of the lightening cylinder 5 by a first pipe 7. In addition, the pressure control valve 6 can take up, in the work configuration of the machine 1, a first position 61 in which it allows hydraulic fluid to flow between the first pipe 7 and a second pipe 8 connecting the pressure control valve 6 to a hydraulic pump P. Also, the pressure control valve 6 can take up, in the work configuration of the machine 1, a second position 62 in which it allows hydraulic fluid to flow between the first pipe 7 and a third pipe 11 connecting the pressure control valve 6 to a tank T. Furthermore, the position of the pressure control valve 6 depends on the pressure in the first pipe 7 such that when the pressure in the first pipe 7 is less than a set value, the pressure control valve 6 takes up the first position and when the pressure in the first pipe 7 is greater than the set value, the pressure control valve 6 takes up the second position. Preferably, the position of the pressure control valve 6 depends only on the pressure in the first pipe 7.

Thanks to these arrangements, the pressure in the active chamber 5′ is kept constant, resulting in constant lightening and thereby better work quality as well as less damage to the plant cover, without the need for an hydro-pneumatic pressure accumulator. Thus, the active chamber 5′ of the lightening cylinder 5 is not connected to any hydropneumatic pressure accumulator in the work configuration of the machine 1. Furthermore, since fluid is only injected in the first position 61 of the pressure control valve 6, the lightening device 9 does not permanently require the use of the pump P, thus reducing the power required to operate the machine 1. Thus, in the second position 62 of the pressure control valve 6, the pump P does not have to supply pressure to the lightening device 9, which means that the fluid is less likely to heat up, thereby retaining its properties for a longer period of time, and reducing the risk of lowering the performance of the machine 1 as well as the necessary oil change frequency. The fact that the position of the pressure control valve 6 does not depend on actuation by the operator, enables that the lightening is constant without the need for human supervision, which may be incorrect or lead to a reaction time that could reduce the quality of work and/or increase the damage to the plant cover.

In the first position 61 of the pressure control valve 6, the third pipe 11 is not connected to the first pipe 7. In this first position 61, the active chamber 5′ of the lightening cylinder 5 is therefore not connected to the tank T. In the second position 62 of the pressure control valve 6, the second pipe 8 is not connected to the first pipe 7. In this second position 62, the active chamber 5′ of the lightening cylinder 5 is therefore not connected to the pump P.

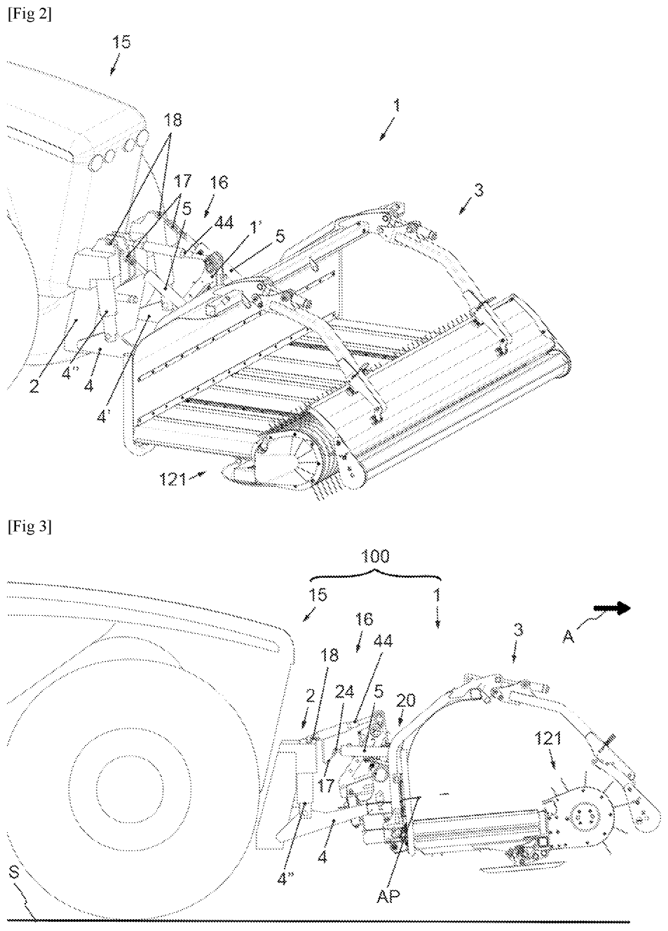

When the machine 1 is operating, it is moved by the tractor vehicle 15 in a direction of advance A. According to the preferred embodiment shown on FIGS. 1 to 3, the machine 1 comprises a frame 1′ carrying the work unit 3. The frame 1′ is configured to connect the work unit 3 to the chassis 2. In the preferred embodiment, the chassis 2 is an integral part of the tractor vehicle 15. In the preferred embodiment, the work unit 3 is articulated with the frame 1′ at least about a pendular axis AP substantially parallel to the direction of advance A. In a simple manner, the pendular axis AP is advantageously located in a midplane PM of the work unit 3. In an alternative embodiment, the work unit 3 is not articulated, such that the frame 1′ is part of the work unit 3.

The work unit 3 is connected to the chassis 2 by two lower arms 4, 4′. In the preferred embodiment, the work unit 3 is also connected to the chassis (2) by an upper arm 44. The machine 1, respectively the frame 1′, comprises two lower hitching points 14, 14′ making it possible to hitch the lower arms 4, 4′. The midplane PM of the work unit 3 is equidistant from the lower hitching points 14, 14′. The machine 1, respectively the frame 1′, also comprises an upper hitching point 14″ making it possible to hitch the upper arm 44. The midplane PM passes through the upper hitching point 14″. The midplane PM is vertical when the machine 1 is resting on horizontal ground S. In addition, the midplane PM is parallel to the direction of advance A. At least one of the lower arms 4, 4′ is connected to the chassis 2 by a lifting cylinder 4″. The tractor vehicle 15 comprises a coupling device 16. The coupling device 16 comprises at least two lower arms 4, 4′, an upper arm 44 and a lifting cylinder 4″. Each arm 4, 4′, 44 is articulated with the work unit 3 on one side, and with the chassis 2 on the other side, at least about substantially horizontal axes, allowing the vertical displacement of the work unit 3 relative to the chassis 2. Preferably, the upper arm 44 and each lower arm 4, 4′ is articulated with the work unit 3 by a ball joint at the respective hitching point 14, 14′, 14″.

The lightening cylinder 5 is connected, directly or indirectly, to the chassis 2 on one side. In other words, the chassis 2 is connected, directly or not, either to the rod or to the body of the lightening cylinder 5. The lightening cylinder 5 is connected to the work unit 3 on the other side. In other words, the work unit 3 is connected to that one of the rod or body of the lightening cylinder 5 which is not connected to the chassis 2. According to an alternative embodiment not shown, the lightening cylinder 5 can also be connected to the chassis 2 on one side and to the work unit 3 via the coupling device 16, respectively via one of the arms 4, 4′, 44.

Preferably, the second pipe 8 is connected to the hydraulic circuit of the tractor vehicle 15 via a control valve 19. The control valve 19 is preferably part of the tractor vehicle 15. The hydraulic circuit of the tractor vehicle 15 comprises the pump P and the tank T. In the work configuration of the machine 1, the control valve 19 is in a first position 191. In its first position 191, the control valve 19 connects the second pipe 8 to the pump P.

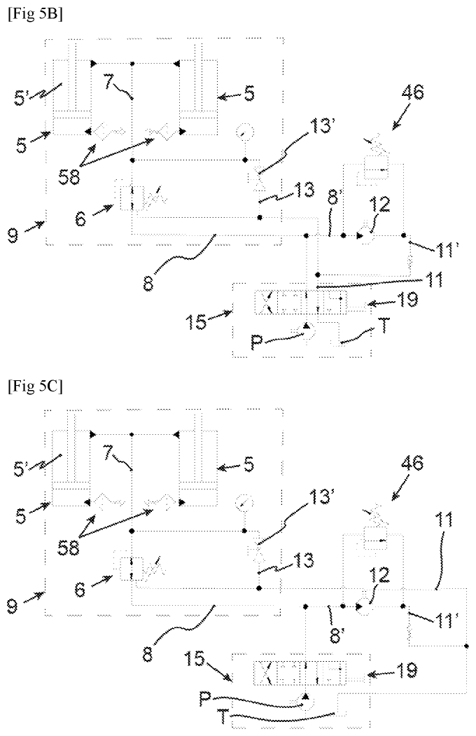

In the embodiment shown on FIG. 5B, the third pipe 11 is also connected to the hydraulic circuit of the tractor vehicle 15 via the or via a control valve 19. On this figure, in its first position 191, the control valve 19 connects the third pipe 11 to the tank T. In the embodiment shown on FIG. 5B, an error in the handling of the control valve 19 can lead not only to the lightening cylinder 5 no longer exerting an upward-directed force on the work unit 3, such that the work unit 3 is more likely to damage the plant cover of the ground S, but also to the or each lightening cylinder 5 coming into contact with the tractor vehicle 15, thus resulting in damages on the tractor vehicle 15 and/or the lightening cylinder 5.

In the preferred embodiment shown on FIG. 5C, the third pipe 11 is connected directly to the or a tank T. As a result, a user cannot connect the third pipe 11 to the pump P, even in case of incorrect handling of the control valve 19. Thus, in the preferred embodiment, there is never any pressure in the third pipe 11.

According to the embodiment shown on FIG. 5B, the second pipe 8 and the third pipe 11 are connected to the hydraulic circuit of the tractor vehicle 15 via a control valve 19. In the work configuration of the machine 1, the control valve 19 is in a first position 191. In the present description, unless indicated otherwise, the control valve 19 must be considered as being in the first position 191 and the machine 1 in the work configuration. The control valve 19 is, for example, a selective slide valve, that can preferably be actuated from the tractor vehicle 15.

To bring the pressure in the hydraulic circuit of the lightening device 9, respectively in the hydraulic circuit of the machine 1, to the atmospheric pressure, the control valve 19 can be placed in a floating position 192. In its floating position 192, the control valve 19 makes it possible to connect the second pipe 8 to the tank T. In the floating position 192, the control valve 19 also connects the tank T to the third pipe (11), if any.

In the work configuration of the machine 1, the lifting cylinder 4″ is in floating mode. In floating mode, the length of the cylinder can vary when the cylinder is subjected to external forces. The floating mode of the lifting cylinder 4″ allows the work unit 3 to move relative to the chassis 2 depending on the relief of the ground S. Preferably, placing the lifting cylinder 4″ in floating mode amounts to connecting its chambers to the tank T.

The active chamber 5′ of the lightening cylinder 5 can be connected to the or to a hydraulic pump P. The active chamber 5′ of the lightening cylinder 5 can also be connected to the or to a tank T. When the active chamber 5′ of the lightening cylinder 5 is connected to the pump P, the lightening cylinder 5 exerts on the frame 1′, respectively on the work unit 3, a force of which at least one component is directed upwards, at least after a certain period of time. The force of the lightening cylinder 5 on the work unit 3 depends on the pressure in the active chamber 5′. Once the set value has been reached in the active chamber 5′, the pressure control valve 6 keeps the pressure in the active chamber 5′ constant in the work configuration, such that the lightening cylinder 5 exerts on the work unit 3 a constant force, of which at least one component is directed upwards. On FIG. 1, the work unit 3 is therefore only resting partially on the ground S, since some of the weight of the machine 1 is transferred onto the chassis 2, respectively onto the front axle of the tractor vehicle 15.

In the transport configuration, as shown on FIG. 3, the work unit 3 is raised from the ground S. The work configuration can be obtained, from the transport configuration, by connecting the active chamber 5′ to the tank T and by extending the lifting cylinder 4″ until the work unit 3 reaches the ground S, after which the lifting cylinder 4″ must be placed in floating mode, and then the active chamber 5′ connected to the pump P. However, with such a transposition method between the transport and work configurations, the machine 1 reaches the ground S violently, which may damage the machine 1 and/or the plant cover of the ground S. The work configuration is thus preferably obtained, from the transport configuration, by placing the lifting cylinder 4″ in floating mode until the work unit 3 reaches the ground (S), and by connecting the active chamber 5′ to a pump P. In order to benefit from a certain stroke of the lightening cylinder 5 when the work unit 3 moves up and down relative to the tractor vehicle 15 from a reference position, the active chamber 5′ of the lightening cylinder 5 is connected to the pump P when the machine 1 and the tractor vehicle 15 are resting on flat ground S. As long as the pressure in the active chamber 5′ has not reached the set value, the pressure control valve 6 is in its first position 61. After a period of time, the pressure in the active chamber 5′ reaches the set value such that the pressure control valve 6 moves to the second position 62.

Referring to FIG. 5A, during the operating of the machine 1, when the pressure in the active chamber 5′ becomes less than the set value, for example when the lightening cylinder 5 retracts because the working unit 3 is on a bump, the pressure control valve 6 moves to the first position 61 and remains in this position until the pressure in the active chamber 5′ becomes greater than the set value. When the pressure in the active chamber 5′ exceeds the set value, for example when the lightening cylinder 5 extends because the work unit 3 is in a hole, the pressure control valve 6 moves to the second position 62 and remains in this position until the pressure in the active chamber 5′ becomes less than the set value. The pressure control valve 6 therefore tends to oscillate between these two positions, keeping the pressure in the active chamber 5′ of the lightening cylinder 5 substantially constant.

As shown on FIG. 5A, the pressure in the first pipe 7 is measured via a control pipe (60) which is part of the pressure control valve 6. Since the first pipe 7 connects the active chamber 5′ to the pressure control valve 6, the pressure in the first pipe 7 is equal to the pressure in the active chamber 5′. The set value is specific to the pressure control valve 6. To be able to adjust the force exerted by the lightening cylinder 5 on the work unit 3, the set value is adjustable, preferably via a spring 68 of the pressure control valve 6. Implementing a spring 68 whose force is adjustable avoids the need for any electronics, thereby reducing the development cost and the cost price and leading to easier maintenance. It appears from the above that the pressure control valve 6 is a single component that can take up only two different positions, thereby reducing the costs, the assembly complexity, as well as the number and length of the hydraulic pipes and connections. The pressure control valve 6 may for example be of the type known by the designation DR10-01 sold by the company Hydac, or a similar control valve. In an alternative embodiment not shown, the pressure control valve 6 could also be controlled electronically or hydraulically, in particular to be able to adjust the set value when operating the machine 1, and in particular from the cab of the tractor vehicle 15.

As shown on FIGS. 5B and 5C, the machine 1 may comprise a hydraulic actuator 12 connected to the second pipe 8 by a fourth pipe 8′. The hydraulic actuator 12 can also be connected to the third pipe 11 by a fifth pipe 11′, preferably at its outlet. The hydraulic actuator 12 performs a function external to the lightening device 9. Such an arrangement makes it possible to perform several functions using a single control valve 19, thus making it possible to reduce the number of control valves required to operate the machine 1. Such a characteristic is interesting for a front-mounted machine 1, especially when the tractor vehicle 15 has only one control valve 19 at the front. The hydraulic actuator 12 preferably comprises at least one hydraulic motor or cylinder. In the examples shown, the work unit 3 comprises a pick-up roller 121 configured to lift a haymaking product such as mowed grass, and to throw it backwards in the direction of advance A. In these examples shown, the hydraulic actuator 12 is the hydraulic motor driving the pick-up roller 121 in rotation. The machine 1 could also be intended to mow a standing plant product, and possibly also to group this product on one side of the machine 1 as it advances.

As shown on FIGS. 5B and 5C, a pressure limiting valve 46 can be mounted on the terminals of the hydraulic actuator 12 to prevent damage to the actuator. Preferably, the pressure limiting valve 46 is connected to the fourth pipe 8′ and to the fifth pipe 11′ so as to limit the pressure in the fourth pipe 8′. The set value above which this pressure limiting valve 46 allows hydraulic fluid to flow between the fourth pipe 8′ and the fifth pipe 11′ can be adjusted. To avoid limiting the pressure in the hydraulic circuit of the lightening device 9, respectively throughout the hydraulic circuit of the machine 1, the set value of the pressure limiting valve 46 is greater than the set value of the pressure control valve 6. Such an embodiment makes it possible to limit the pressure in the hydraulic actuator 12 without however limiting the pressure in the lightening cylinder 5, while using the same control valve 19 for the hydraulic actuator 12 and the lightening cylinder 5. Furthermore, the position of the pressure limiting valve 46 on the terminals of the hydraulic actuator 12 enables the force exerted by the lightening cylinder 5 on the work unit 3 remains constant. If such a pressure limiting valve 46 was connected to the first pipe 7, the pressure in the active chamber 5′ of the lightening cylinder 5 would be limited by the smallest value between the set value of the pressure control valve 6 and the set value of the pressure limiting valve 46.

As shown on FIGS. 5B and 5C, to avoid disturbing the operation of the or of each hydraulic actuator 12 when the pressure control valve 6 is in its second position 62, a non-return valve can be fitted on the fifth pipe 11′ so as to block the flow of hydraulic fluid to the hydraulic actuator 12.

The machine 1 comprises a drain pipe 13 fitted with a stop valve 13′, closed in the work configuration. This drain pipe 13 connects the first pipe 7 to the third pipe 11. In the present description, unless otherwise indicated, the stop valve 13′ is considered as being closed. Such an arrangement makes it possible, by opening the stop valve 13′, to easily and quickly drain the lightening cylinder 5 without the control valve 19. So that the user can know the pressure in the active chamber 5′ of the lightening cylinder 5, a pressure gauge is fitted in series on the first pipe 7 or on the drain pipe 13.

In the preferred embodiment, the pump P, the tank T and the control valve 19 are integral parts of the tractor vehicle 15. To avoid placing too much stress on the hydraulic circuit of the tractor vehicle 15, which could lead to a disruption of one or some of the functions of the machine 1, it is nevertheless possible for the pump P, the tank T and the control valve 19 to be integrated in the machine 1, especially if the machine 1 comprises several work units 3. In addition, a machine 1 comprising the pump P and the tank T makes it possible to better control the cleanliness of the hydraulic fluid.

In the preferred embodiment shown on FIGS. 1 to 3, the lightening cylinder 5 is connected to the chassis 2 by a flexible tie-rod 17. The flexible tie-rod 17 is attached to the lightening cylinder 5 at an anchoring point 24. The flexible tie-rod 17 is attached to the chassis 2 at a fastening point 18. The flexible tie-rod 17 is not able to spread compression. The flexible tie-rod 17 is for example a cable (FIG. 3) or a chain (FIG. 1). It could also be a device comprising a pin attached to either the chassis 2 or the lightening cylinder 5 and being able to move freely in the oblong hole of a part attached to that of the chassis 2 and of the lightening cylinder 5 which is not attached to the pin. In a simple manner and as shown on FIGS. 1 to 3, the flexible tie-rod 17 is a chain, it being advantageously possible to use each link to attach the lightening cylinder 5 to the chassis 2 at the fastening point 18. Thus, regardless of the tractor vehicle 15 to which the machine 1 is connected, the work unit 3 can rest on the ground S. The lightening cylinder 5 is rigidly connected to the work unit 3 at a front articulation 20. If applicable, the lightening cylinder 5 is attached to the work unit 3 via the frame 1′ at this front articulation 20. The length between the fastening point 18 and the front articulation 20 can be modified by means of the various fasteners of the flexible tie-rod 17. The machine 1 can thus be easily coupled to tractor vehicles 15 of different types and/or different heights, without having to adapt the stroke of the lightening cylinder 5 to them. At least in the work configuration, since the fastening point 18 is further away from the ground S than the front articulation 20 of the lightening cylinder 5 with the frame 1′, the force exerted by the lightening cylinder 5 on the work unit 3 is at least partially directed upwards.

As shown on FIG. 5A, the lightening cylinder 5 comprises an active chamber 5′ connected to the first pipe 7. The lightening cylinder 5 also comprises a passive chamber 5″ separated from the active chamber 5′ by a piston. The passive chamber 5″ is connected to the open air. The passive chamber 5″ is preferably connected to the open air by a venting pipe 58. The venting pipe 58 is a plug allowing air to pass through, preferably filtering it.

The lightening cylinder 5 can be of the single-acting type. Thus, the lowering of the work unit 3 of a machine 1 as described above can be obtained thanks to the weight of the work unit 3 and to gravity. Such an embodiment makes it possible to reduce the number of hydraulic pipes by at least one, thereby making the machine 1 easier to manufacture and to connect to the control valve 19.

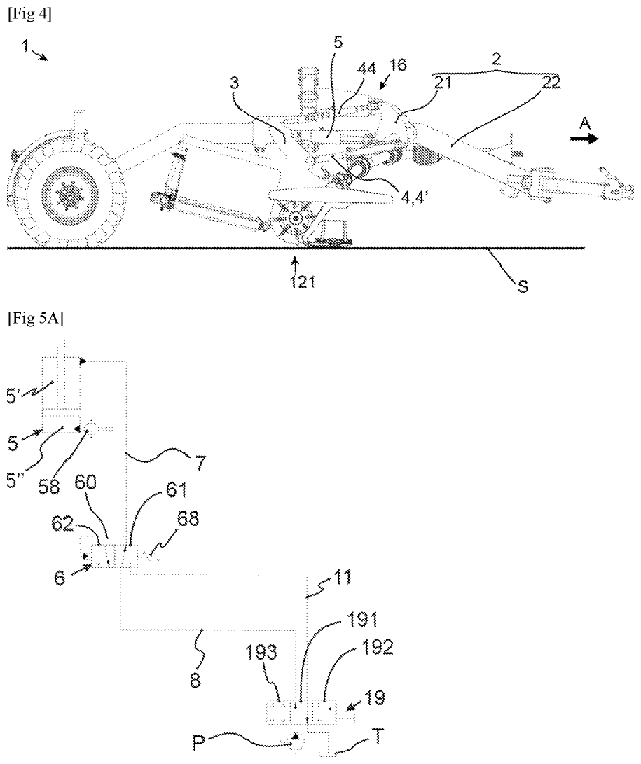

Since the lightening cylinder 5 is connected to the chassis 2 by a flexible tie-rod 17, the lightening cylinder 5 only transfers a force between the chassis 2 and the work unit 3 as it retracts. The active chamber 5′ is preferably located on the side of the rod of the lightening cylinder 5. The passive chamber 5″ is preferably located on the side of the body of the lightening cylinder 5. It would be possible to connect the rod of the lightening cylinder 5 to the work unit 3 and the side of the body of the lightening cylinder 5 to the chassis 2. However, the weight distribution would be disadvantageous, since the side of the body is heavier than the side of the rod. In addition, connecting the rod of the lightening cylinder 5 to the frame 1′ does not make it possible to position the front articulation 20 anywhere other than at the end of the lightening cylinder 5, respectively at the free end of its rod, without limiting its stroke. As shown on FIG. 1, the rod of the lightening cylinder 5 is preferably connected to the chassis 2. The side of the body of the lightening cylinder 5 is, for its part, connected to the work unit 3 and articulated with the frame 1′, respectively with the work unit 3, elsewhere than at the end of the lightening cylinder 5, without limiting the stroke of the lightening cylinder 5 (see FIGS. 3 and 4). The lightening cylinder 5 therefore operates like a single-acting cylinder whose chamber connected to the open air is connected on the side of its body, i.e. the passive chamber 5″. It appears from the above that when the pump P is connected to the active chamber 5′, the lightening cylinder 5 exerts a force on the work unit 3, of which at least one component is directed upwards. In addition, the fact that the machine 1 comprises a lightening cylinder 5 that can only be actuated in retraction makes it impossible, in the transport configuration, to extend the lightening cylinder 5, which could otherwise hit the chassis 2, respectively the tractor vehicle 15, and cause damage.

In the preferred embodiment, the machine 1 comprises two lightening cylinders 5. The two lightening cylinders 5 are identical and assembled substantially symmetrically with respect to the midplane PM. As shown on FIGS. 5B and 5C, the active chamber 5′ of each of the lightening cylinders 5 is connected to the first pipe 7. Everything described above for the lightening cylinder 5 is valid for both lightening cylinders 5, respectively for each of the lightening cylinders 5. The cylinders 5 are arranged on either side of the pendular axis AP seen in the direction of advance A, making it possible to equally distribute the lightening on either side of the pendular axis AP, regardless of the relief of the ground S.

The invention also relates to an agricultural convoy 100 comprising a tractor vehicle 15 and a machine 1 according to the preferred embodiment. The invention also relates to a method for transposing an agricultural machine 1 according to the embodiment of FIGS. 1 to 3, between its transport configuration and its work configuration. This method can be used to transpose the agricultural machine 1 intended to be coupled to a tractor vehicle 15 equipped with a coupling device 16 comprising at least one lifting cylinder 4″, between its transport configuration and its work configuration, the machine 1 comprising a work unit 3 connected to a chassis 2 of the tractor vehicle 15 relative to which the work unit 3 can be moved. This method for transposing between the transport configuration and the work configuration consists, from its transport configuration, in hydraulically connecting the or an active chamber 5′ of the lightening cylinder 5 to the or to a pump P, and in placing the lifting cylinder 4″ in floating mode until the work unit 3 reaches the ground S. These steps can be performed in any order. Preferably, these steps are carried out chronologically in their order of appearance to avoid a sudden shock to the machine 1 and/or damage to the ground S at this point. If the work unit 3 reaches the ground S before connecting the active chamber 5′ of the lightening cylinder 5 to the pump P, the machine 1 reaches the ground S violently, which may damage the machine 1 and/or the plant cover of the ground S at this point. The work configuration is thus preferably obtained, from the transport configuration, by first hydraulically connecting the active chamber 5′ to the pump P, and then hydraulically connecting the lifting cylinder 4″ to a or to the tank T until the work unit 3 reaches the ground S. It is understood from the above that the work configuration is obtained, from the transport configuration, by first hydraulically connecting the active chamber 5′ to the pump P, and then, while maintaining this hydraulic connection between the pump P and the active chamber 5′, by hydraulically connecting the lifting cylinder 4″ to a or to the tank T until the work unit 3 reaches the ground S.

Specifically, hydraulically connecting the active chamber 5′ of the lightening cylinder 5 to the pump P is preferably carried out by placing the control valve 19 in its first position 191.

If, unlike the above-mentioned method, in the work position, a user prevents any flow of hydraulic fluid from and to the active chamber 5′ of the lightening cylinder 5, for example by placing the control valve 19 in the closed position 193, and then raises the work unit 3, for example by retracting the lifting cylinder 4″, then the lightening cylinder 5 could hit the tractor vehicle 15 and cause damage to the machine 1 and/or to the tractor vehicle 15. Thus, preventing any flow of hydraulic fluid from and to the active chamber 5′ of the lightening cylinder 5 implies maintaining the length of the lightening cylinder 5. In the transport configuration, however, the anchoring point 24 is closer to the chassis 2 and/or to the tractor vehicle 15 than in the work configuration. The above-mentioned method for transposing the machine 1 between its transport and work configurations thus prevents damage to the machine 1 and/or to the tractor vehicle 15.

Transposing the machine 1 between its work configuration and its transport configuration consists in raising the machine 1 using the coupling device 16, preferably by retracting the lifting cylinder 4″, and then preventing any flow of hydraulic fluid between the machine 1 and the tractor vehicle 15, preferably by isolating the second pipe 8 by means of the control valve 19. Uncoupling the machine 1 from the tractor vehicle 15 consists, from the work configuration, in first preventing any flow of hydraulic fluid between the active chamber 5′ and the tractor vehicle 15, keeping the or each lightening cylinder 5 at a constant length, then in raising the work unit 3 until the or each flexible tie-rod 17 is unloaded, then in detaching from the chassis 2, respectively from the fastening point 18, the or each lightening cylinder 5, respectively the or each flexible tie-rod 17, then in placing the machine 1 back on the ground S using the coupling device 16, respectively the lifting cylinder 4″, and lastly in detaching each arm 4, 4′, 44 from its respective hitching point 14, 14′, 14″ as well as disconnecting the second and third hydraulic pipes 8, 11 from the hydraulic circuit of the tractor vehicle 15. To keep the rod of the lightening cylinder 5 clean and smooth, it is also recommended to connect the active chamber 5′ to the pump P until the lightening cylinder 5 is completely retracted, before disconnecting the second and third hydraulic pipes 8, 11 from the hydraulic circuit of the tractor vehicle 15.

In practice, the step of preventing any flow of hydraulic fluid between the active chamber 5′ and the tractor vehicle 15 is to place the control valve 19 in the closed position 193. In its closed position 193, the control valve 19 blocks the flow of hydraulic fluid at least between the second pipe 8 and the pump P.

In an embodiment variant shown on FIG. 4, the chassis 2 is an integral part of the machine 1. The dimensions of the or of each lightening cylinder 5 being adaptable to the chassis 2, respectively to its height in work configuration, in this variant, the lightening cylinder 5 is not necessarily connected to the chassis 2 by a flexible tie-rod 17. In this variant, the chassis 2 comprises a carrier frame 22 and at least one support arm 21. In addition, the lightening cylinder 5 connects the support arm 21 to the work unit 3. The carrier frame 22 comprises a coupling frame configured to couple the machine 1 to a tractor vehicle 15. The support arm 21 carries at least one work unit 3. The support arm 21 is articulated on the carrier frame 22 about an axis that is oriented so as to be able to reduce the width of the machine 1, and preferably oriented parallel to the direction of advance A. To transpose the machine 1 between its work and transport configurations, the or each support arm 21 is pivoted about this axis together with the work unit 3.

In this variant shown on FIG. 4, the lightening cylinder 5 can also be used to place the work unit 3 in a so-called maneuvering configuration in which the work unit 3 is slightly raised from the ground S to maneuver in a field with the tractor vehicle 15. The invention also relates to an agricultural convoy 100 comprising a tractor vehicle 15, at least one machine 1 according to the variant shown on FIG. 4 and a machine 1 according to the preferred embodiment.

Obviously, the invention is not limited to the embodiments described and shown in the attached drawings. Modifications remain possible, in particular as regards the composition of the various elements or the substitution by technical equivalents without departing from the scope of protection of the invention.

1. Agricultural machine intended to be coupled to a tractor vehicle and comprising a work unit connected to a chassis relative to which the work unit can be moved, the machine being able to take up a work configuration in which the work unit rests at least partially on the ground and a transport configuration in which the work unit is raised from the ground, the machine comprising a lightening device having at least one lightening cylinder connected to the chassis on one side and to the work unit on the other side, the lightening cylinder being able to transfer, in the work configuration, at least some of the weight of the work unit onto the chassis, wherein the lightening device comprises a pressure control valve connected to an active chamber of the lightening cylinder by a first pipe, the pressure control valve being able to take up, in the work configuration of the machine, a first position in which it allows hydraulic fluid to flow between the first pipe and a second pipe connecting the pressure control valve to a hydraulic pump, and a second position in which it allows hydraulic fluid to flow between the first pipe and a third pipe connecting the pressure control valve to a tank, the position of the pressure control valve depending on the pressure in the first pipe such that when the pressure in the first pipe is less than a set value, the pressure control valve takes up the first position and when the pressure in the first pipe is greater than the set value, the pressure control valve takes up the second position.

2. Agricultural machine according to claim 1, wherein the machine comprises an hydraulic actuator connected to the second pipe by a fourth pipe.

3. Agricultural machine according to claim 2, wherein a pressure limiting valve is mounted on the terminals of the hydraulic actuator and in that the set value of the pressure limiting valve is greater than the set value.

4. Agricultural machine according to claim 1, wherein the third pipe is connected directly to the or to a tank.

5. Agricultural machine according to claim 1, wherein the second pipe is connected to the hydraulic circuit of the tractor vehicle via a control valve.

6. Agricultural machine according to claim 1, wherein the machine comprises a drain pipe fitted with a stop valve closed in the work configuration, this drain pipe connecting the first pipe to the third pipe in bypass of the pressure control valve.

7. Agricultural machine according to claim 1, wherein the lightening cylinder is connected to the chassis by a flexible tie-rod.

8. Agricultural machine according to claim 1, wherein the lightening cylinder comprises a passive chamber separated from the active chamber by a piston, the passive chamber being connected to the open air.

9. Agricultural machine according to claim 1, wherein, in the first position of the pressure control valve, the third pipe is not connected to the first pipe.

10. Agricultural machine according to claim 1, wherein, in the second position of the pressure control valve, the second pipe is not connected to the first pipe.

11. Agricultural machine according to claim 1, wherein the active chamber of the lightening cylinder is not connected to any hydropneumatic pressure accumulator in the work configuration of the machine.

12. Agricultural machine according to claim 5, wherein, in the work configuration of the machine, the control valve is in a first position in which it connects the second pipe to the pump and in which it connects the third pipe to the tank.
